(19) United States
(12) Patent Application Publication
(10) Pub. No.: US 2025/0091424 A1
(43) Pub. Date: Mar. 20, 2025

(54) FLOOR FRAME FOR A MOTOR VEHICLE BODY

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,952

(22) Filed: Sep. 13, 2024

(30) Foreign Application Priority Data
Sep. 14, 2023 (DE) 102023124889.8

(51) Int. Cl. B60K 1/04; B62D 21/03

(52) U.S. Cl. CPC B60K 1/04; B62D 21/03; B60K 2001/0438

(57) ABSTRACT

The present disclosure relates to a floor frame for a motor vehicle body, having at least one, two longitudinal members which extend in the longitudinal direction (X) of the motor vehicle and at least two cross members which extend in the transverse direction (Y) of the motor vehicle, wherein the cross members and longitudinal members have a profiled cross-section, characterized in that the floor frame is produced from a one-piece tailored blank in one press stroke and the floor frame has connection holes for a battery support and in that the cross member has a lower tensile strength Rm and/or wall thickness in its end regions relative to the central region of the cross member.

### RELATED APPLICATIONS

The present application claims priority of German Application Number 10 2023 124 889.8 filed Sep. 14, 2023, the disclosure of which is hereby incorporated by reference herein in its entirety.

### FIELD

The present disclosure relates to a floor frame for a motor vehicle body.

### BACKGROUND

Motor vehicles are driven by an internal combustion engine and increasingly also by an electric motor. Such motor vehicles are also referred to as automobiles. They usually have a self-supporting vehicle body or bodywork. Such a body is made up of various sheet metal components. The sheet metal components are manufactured individually, for example A-pillar, B-pillar, C-pillar, a sill, a floor sheet metal, cross members or longitudinal members. These are each formed as a one-piece shell component. The precision to be obtained of the individual component is good. The components are then joined together to form the self-supporting motor vehicle body. This joining operation again results in tolerances.

A floor frame for a motor vehicle is described in WO 2020/058 037 A1 for accommodating a corresponding energy storage unit. The floor frame is made from cross members and longitudinal members that are coupled together.

DE 10 2018 211 473 B3 describes a battery housing for an electric motor vehicle. In this case, a support is inserted into a peripheral frame and closed by means of sealing lines.

### SUMMARY

The object of the present disclosure provides a floor frame for a motor vehicle which is able to be manufactured more efficiently and cost-effectively than the floor frame, which at the same time has a high precision in terms of the component accuracy to be achieved and which also has improved rigidity behavior and improved crash properties. The aforementioned object is achieved with a floor frame for a motor vehicle body.

The floor frame is for a self-supporting motor vehicle body or bodywork. The floor frame is thus inserted into the body and joined thereto, e.g., welded. A further floor sheet metal, which provides the floor sheet metal itself, is realized with the floor frame. The floor frame is therefore a stiffening structure for the motor vehicle body.

For this purpose, the floor frame has at least one longitudinal member, for example, two longitudinal members, extending in the longitudinal direction of the motor vehicle. The floor frame also has cross members extending in the transverse direction of the motor vehicle. In some embodiments of the present disclosure, two cross members, or three cross members, are provided. The floor frame thus has a ladder structure when viewed from above.

The cross members as well as the longitudinal members themselves have a profiled cross-section, at least in longitudinal portions. The floor frame is made in one piece from a tailored blank, e.g., a tailored welded blank, in one press stroke. This means that the tailored blank is initially provided as a sheet metal blank. Longitudinal member and cross member portions are therefore already provided and are then profiled in cross-section by the press stroke itself. The entire floor frame structure is therefore in one piece. In the case of a tailored rolled blank, one-piece means, for example, one-piece and uniform in material. In the case of a tailored welded blank, one-piece means that the individual sheet metal strips are first welded together to form the tailored welded blank and then the one-piece sheet metal blank is formed in one press stroke. A large-capacity press is used to produce the floor frame. In plan view, the floor frame has a size of more than 100×100 cm, or more than 150×100 cm.

According to the present disclosure, the floor frame is now characterized by the fact the floor frame has connection holes for a battery support. These connection holes are able to be referred to as battery support connection holes. The immediately adjacent region surrounding the battery support connection holes is reinforced by a greater wall thickness and/or greater tensile strength Rm.

Furthermore, according to the present disclosure, the floor frame is characterized in that the cross members have a lower wall thickness and/or lower tensile strength at their outer ends or end regions in relation to the transverse direction of the motor vehicle, with respect to a central region of the cross members and/or to the longitudinal members.

This achieves two advantages according to the present disclosure. On the one hand, battery support connection holes are able to be reinforced so that a battery support, which has a dead weight including battery of several 100 kg, are able to be securely mounted with the floor structure of the motor vehicle in a connection-stiff and durable manner.

A lower wall thickness and/or lower tensile strength in the end regions of the cross members provides a high level of rigidity in the event of a crash, for example, in side crash behavior, but at the same time the end region is deformed in the manner of a crash box and thus dissipates energy. In contrast, a central region of the cross member itself, in relation to the longitudinal direction of the cross member, is softer or more ductile. A crumple zone is able to form here, whereby the passengers sitting on the left or right side of the motor vehicle are protected from crashes in the resulting passenger cell of the motor vehicle body thanks to the higher external rigidity of the cross member.

In at least one embodiment of the present disclosure, the longitudinal members to be offset inwards in relation to the transverse direction of the motor vehicle. As a result, the ladder-like structure is designed as a cross-like structure, in that the longitudinal members protrude on the outside.

In at least one embodiment of the present disclosure, however, the longitudinal members are arranged on the outside in relation to the transverse direction of the motor vehicle. In this case, the longitudinal members are able to be a sill shell or sill half-shell. The vehicle sills, which are oriented in the motor vehicle body direction and thus in the longitudinal direction of the motor vehicle, are arranged on the outside of the floor frame and form the motor vehicle sill on the inside as an existing part of a half-shell.

In the case of a tailored welded blank, longitudinal members and cross members are able to form a double layer in a coupling region or crossing region. The sheet metal blank is able to be provided simply and cost-effectively with spot welds.

In at least one embodiment of the present disclosure, the sheet metal blank is a pre-coated starting material, a hardened steel material that is pre-coated with an aluminum-silicon coating, for example. In at least one embodiment of the present disclosure, when using hot forming and press hardening technology, the floor frame provided is able to have improved corrosion protection properties.

Alternatively, the tailored welded blank is able to be formed, at least in portions, by butt-jointed individual sheets that form the transition regions from the cross member to the longitudinal member. These are then welded together as butt cutting welds, for example, by means of a laser welding process.

Furthermore, by using hot forming and press hardening technology, a high tensile strength Rm is formed in the region with high strength. This strength is then designed as a tensile strength greater than 980 MPa, greater than 1,350 MPa. The tensile strength is able to be greater than 1,500 MPa, greater than 1,800 MPa, at least in some regions. In at least one embodiment of the present disclosure, a high level of rigidity is able to be provided by the floor frame. If the floor frame itself is coupled with a floor sheet metal, the floor sheet metal is able to provide sufficient ductility so that the floor frame and floor sheet metal achieve a high rigidity, such as torsional rigidity, of the motor vehicle body, while at the same time providing a high crash performance in the event of a crash.

The longitudinal members and/or cross members are U-shaped in the respective cross-section, at least in longitudinal portions, and hat-shaped. This means that outwardly projecting flanges are formed at the ends of the webs of the U-shaped profile. These are able to be provided as connection regions with a floor sheet metal. In at least one embodiment of the present disclosure, the flanges themselves are soft in the form of so-called soft zones, i.e. with a tensile strength of 500 MPa to 850 MPa. If spot welds are made here, tearing of the floor sheet metal joined with them or, in the case of the longitudinal members, of the other sill shells, is avoided, thus providing high ductility through high strength and, at least in some regions of the cross-section in the U-shaped region, simultaneously providing high rigidity and good crash safety.

Further advantages, features, properties and aspects of the present disclosure are the subject of the following description. Various embodiments are shown in schematic figures. These serve to facilitate understanding of the present disclosure. In the figures:

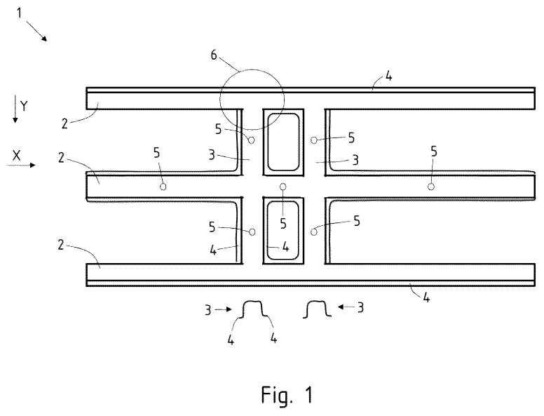

FIG. 1 shows a plan view of a floor frame with respective cross-sectional views according to at least one embodiment,

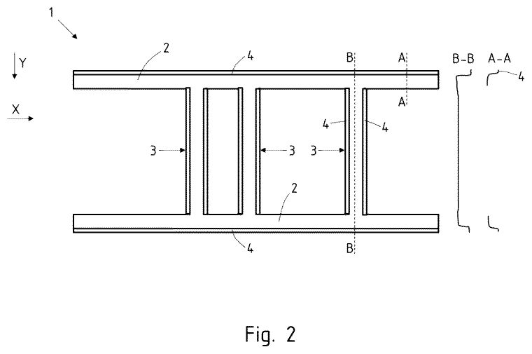

FIG. 2 shows an analogous embodiment variant as shown in FIG. 1 according to the present disclosure,

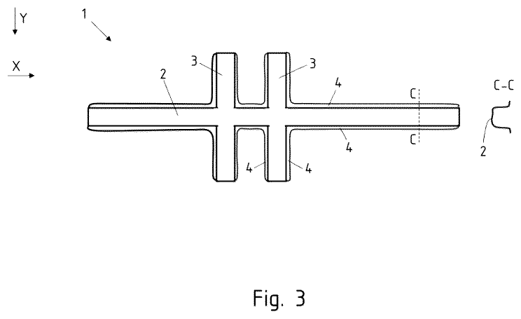

FIG. 3 shows an alternative embodiment variant of the floor frame according to the present disclosure,

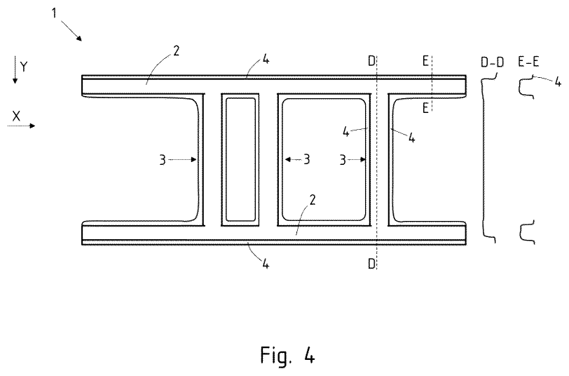

FIG. 4 shows an alternative embodiment variant to FIG. 2 according to the present disclosure,

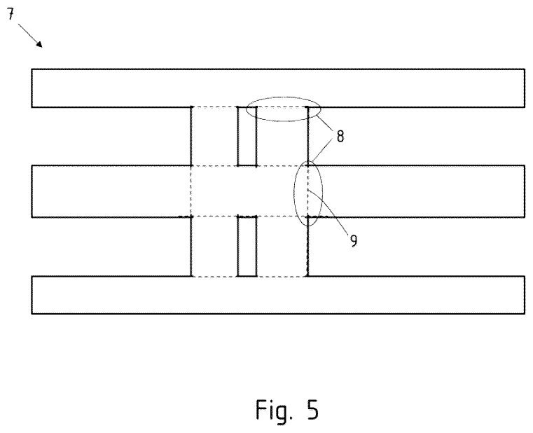

FIG. 5 shows a plan view of a sheet metal blank for the production of a floor frame according to FIG. 1 of the present disclosure,

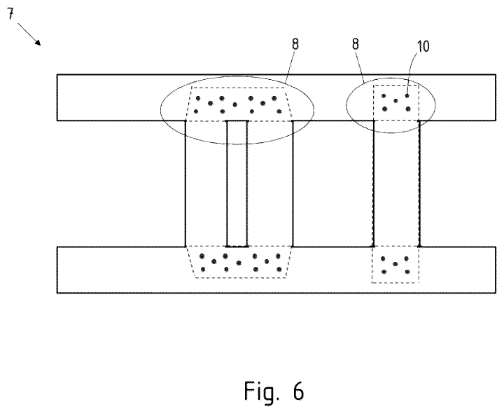

FIG. 6 shows an alternative embodiment variant for the production of a floor frame according to FIG. 2 of the present disclosure,

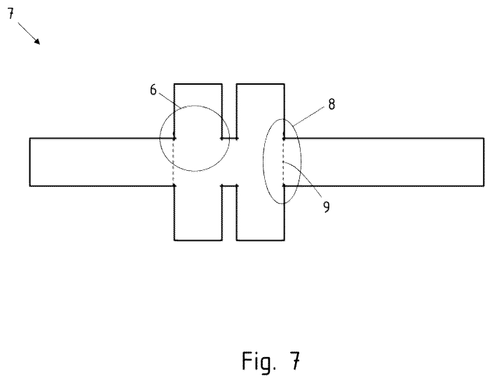

FIG. 7 shows alternative sheet metal blanks for the production of a floor frame as a tailored welded blank with butt joint seams according to at least one embodiment,

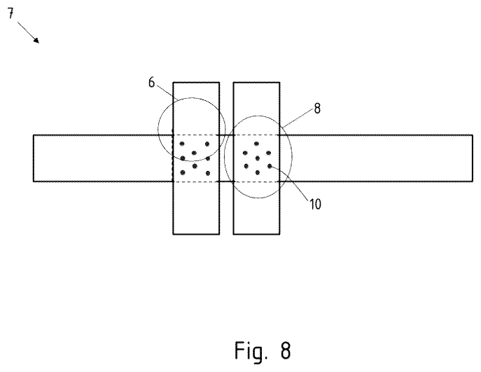

FIG. 8 shows alternative sheet metal blanks for the production of a floor frame with a respective overlap region, which has a double layer formed as a tailored welded blank with spot welds according to at least one embodiment,

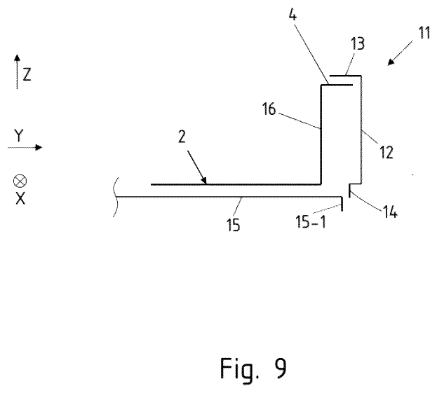

FIG. 9 shows a cross-sectional view of a resulting motor vehicle sill according to at least one embodiment,

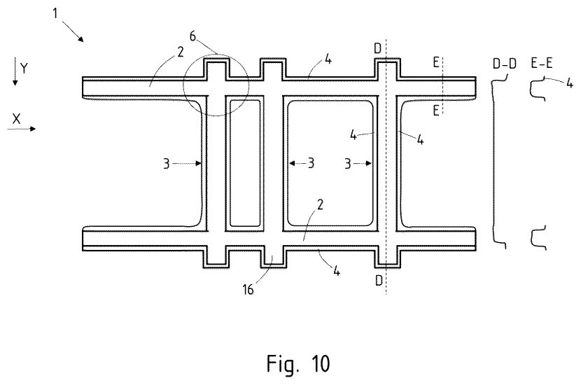

FIG. 10 shows a plan view of a floor frame analogous to FIG. 4 according to at least one embodiment, and

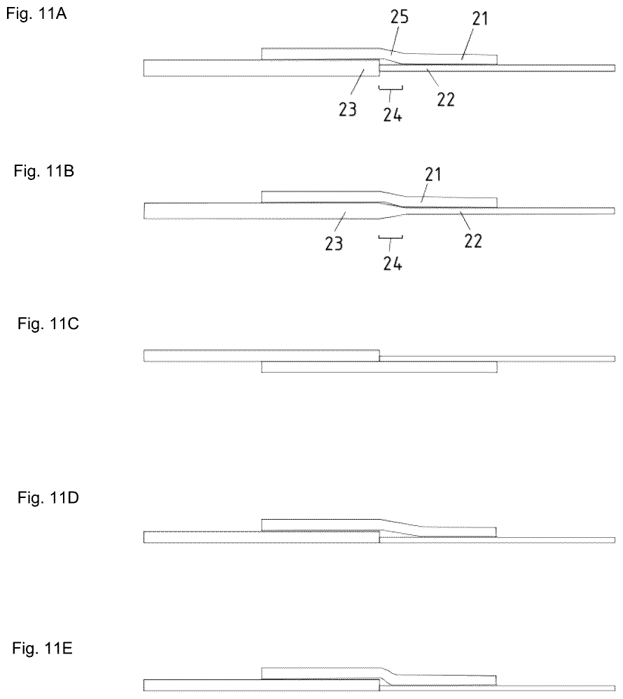

FIG. 11A to FIG. 11E show various cross-sectional views of a tailored welded blank in which two butt-jointed sheet metals are covered with a patch according to at least one embodiment.

### DETAILED DESCRIPTION

In the figures, the same reference symbols are used for identical or similar components, although a repeated description is omitted for reasons of simplification.

FIG. 1 shows a plan view of a floor frame 1 with respective cross-sectional views. The floor frame 1 is shown here with three longitudinal members 2, which are arranged in the longitudinal direction X of the motor vehicle. Furthermore, the floor frame 1 has two cross members 3. The cross members 3 are arranged in the Y direction of the motor vehicle. In the respective cross-sections, the cross members 3 are themselves arranged in the shape of a hat. They therefore have a U-shaped portion and flanges 4 arranged at each end. The flanges 4 are soft or in the form of a so-called soft zone. For coupling with a floor sheet metal not shown in detail, the flanges 4 are then ductile and would not tear off in the event of a crash. In at least one embodiment of the present disclosure, the U-shaped portion is designed with a higher strength, so that sufficient rigidity is achieved in the cross-section.

According to the present disclosure, respective connection holes 5 are able to be formed for a battery support not shown in more detail. These connection holes 5 also have a greater wall thickness in the region adjacent to the connection holes 5. A battery support with a dead weight of several 100 kg is able to be securely and permanently coupled to the floor frame 1 over the service life of a motor vehicle without the need for additional stiffening structures in the underbody region. Furthermore, the wall thickness and/or tensile strength of the cross member 3 is increased in a respective end region 6, indicated here schematically by the circle. This ensures improved crash behavior in the event of a side crash in the transverse direction Y of the motor vehicle. If a central region of the cross member 3 is then softer in the transverse direction Y of the motor vehicle, a crumple zone remains which provides sufficient ductility.

FIG. 2 shows an analogous embodiment variant to FIG. 1, but here three cross members 3 are shown and no central longitudinal member 2 is formed, meaning that only two outer longitudinal members 2 are provided, resulting in a ladder frame structure in plan view. The longitudinal members 2 are shown in the respective cross-sections, which then have an L-shaped configuration on the outside in cross-section. A flange 4 is also able to protrude outwards again here in relation to the motor vehicle's transverse direction Y. A longitudinal section through a cross member 3 is also shown according to section line B-B. This then has a trough-shaped configuration in longitudinal section. The outer L-shaped regions of the longitudinal member 2 are able to serve as an inner partial shell or half-shell for a sill of a vehicle body, which is not shown in detail. An outer sill half-shell is then formed on the outside in relation to the motor vehicle transverse direction Y with the longitudinal member 2. The floor sheet metal, which is not shown in detail and is coupled to the floor frame 1, is able to provide an outer sill, at least partially in cross-section. The sill itself then extends in the longitudinal direction X of the motor vehicle. In this case, the respective outer longitudinal member 2 of the floor frame 1 is also designed with a high degree of strength. The flange 4 of the longitudinal member 2 itself is able to be ductile in the form of a soft zone. This ensures that sufficient rigidity is provided for a side crash, also a side pole test. An outer sill shell, not shown in detail, is able to be ductile, so that the intensity of the initial contact is reduced in the event of a crash. However, the rigidity of the sill is provided by the floor frame 1 and, a high tensile strength of more than 1,000 MPa.

FIG. 3 shows an alternative embodiment variant of the floor frame 1 according to the present disclosure. A cross-like structure is formed in this case. The floor frame 1 is manufactured with a hat-shaped longitudinal member 2 in cross-section and two cross members 3 arranged transversely thereto. In this case, the cross members 3 and longitudinal member 2 are each configured in a hat shape.

FIG. 4 shows an alternative embodiment variant to FIG. 2. In this case, the outer longitudinal members 2 are themselves hat-shaped in their respective cross-section.

FIG. 5 shows a plan view of a sheet metal blank 7 for manufacturing a floor frame 1 as shown in FIG. 1. The sheet metal blank 7 has strips that form the later cross members 3 and sheet metal strips that form the later longitudinal members 2. These are all butt-jointed at transition regions 8 and welded together in the region of the dotted line to form a butt joint 9. For example, as a laser weld seam. This provides a tailored welded blank. The individual sheet metal portions are each able to be homogeneous in terms of wall thickness and/or material. However, the individual sheet portions themselves are able to vary in longitudinal direction, for example in the wall thickness. This means that the specific property of the floor frame 1 to be produced later is able to be preset via the sheet metal blank 7 or the individual sheet metal strips of the sheet metal blank 7.

FIG. 6 shows an alternative embodiment variant. In this case, the sheet metal blank 7 has an overlap in the transition regions 8 for the production of a floor frame 1 as shown in FIG. 2. This overlap makes the spot welds 10 shown able to be made. This process also provides a tailored welded blank. This tailored welded blank is able to be produced easily and cost-effectively using spot welds 10.

A common feature of all embodiment variants is that further centering is produced in a large press both in the transverse direction Y and in the longitudinal direction X of the motor vehicle, so that the cross member 3 and/or longitudinal member 2 is not only a highly precise component in terms of its cross-section, but all cross members 3 and all longitudinal members 2 together are calibrated directly in relation to each other in the forming press with regard to respective positions in the longitudinal direction X and transverse direction Y of the motor vehicle. The floor frame 1 and thus the connecting structure of the floor in the rest of the motor vehicle body is thus optimally prepared.

Another special feature in FIG. 6 as a possible option is that the two sheet metal strips, which in FIG. 2 form two cross members 3 in relation to each other, are continuously connected to each other and to the longitudinal member 2 by an end overlap region. In producing the sheet metal blank 7, depending on the number of cross members 3 to be produced, centering can therefore also be carried out cost-efficiently and economically during the production of the sheet metal blank 7.

FIG. 7 and FIG. 8 show alternative sheet metal blanks 7 for manufacturing a floor frame 1 according to FIG. 3, in the case of FIG. 7 as a respective tailored welded blank with butt joint seams and in the case of FIG. 8 with a respective overlap region, which forms a double layer as a tailored welded blank with spot welds 10.

FIG. 9 shows a cross-sectional view of a resulting vehicle sill 11. The sill 11 itself extends with its longitudinal course in the motor vehicle X-direction. The sill 11 is formed by the outer part of the longitudinal member 2 with the connection flange 4. This forms an inner half-shell in relation to the transverse direction Y of the motor vehicle. There is also an outer sill sheet metal 12. This also has a connection flange 13. This is coupled to the connection flange 4 of the longitudinal member 2. A lower connection flange 14 of the sill sheet metal 12 is coupled to the illustrated floor sheet metal 15 along a downwardly bent floor flange 15-1. The motor vehicle sill 11 is thus formed as a hollow profile in cross-section. The sill sheet metal 12 is able to be an unhardened sheet metal, thus having a tensile strength of approx. 400 MPa to 800 MPa. The longitudinal member 2 is designed as a high-strength component with a tensile strength Rm>1,000 MPa, at least in the region of the web 16 related to the motor vehicle's vertical direction Z. The connection flange 4 of the longitudinal member 2 is soft. The floor sheet metal 15 is also soft or ductile. This ensures sufficient ductility in the joint regions between 4 and 13 as well as 14 and 15 and prevents tearing in the event of a crash. The lower region of the longitudinal member 2, indicated by the arrow at reference 2, is able to be ductile. However, sufficient rigidity is achieved by a high tensile strength Rm and/or greater wall thickness Rm in the region of the web 16. This rigidity counteracts deformation in the longitudinal direction X of the motor vehicle. In the event of a side crash in the transverse direction Y of the motor vehicle, a high degree of rigidity is also achieved so that no intrusion into the passenger compartment occurs.

FIG. 10 shows a top view of a floor frame 1 similar to FIG. 4, although the ends 16 of the cross members 3 are longer than the longitudinal members 2 in the transverse direction Y of the motor vehicle. For these, but also all other variants, the end regions 6 or connection regions of the cross members 3 and/or longitudinal members 2 are thinner in the respective wall thickness and/or have a lower tensile strength compared to the remaining regions of the same cross member 3.

FIG. 11A to FIG. 11E show five different thickness transitions of a sheet metal blank as a tailored welded blank. In each case, a thin sheet 22 is butt-welded to a relatively thicker sheet 23 or, in the case of FIG. 11B, a tailored rolled blank in which the thickness transition occurs from both sides. A reinforcing patch 6 or patch is placed on one side in the region of the thickness transition 24. This patch 21 additionally reinforces the region of the thickness transition. In the case of FIG. 11A and FIG. 11b as well as FIG. 11D and FIG. 11E, the reinforcing patch has a bend 25 in its cross-section so that it compensates for the thickness jump 24 or thickness transition. In the case of FIG. 11C, one side of the thick sheet metal 23 and thin sheet metal 22 is flat, so that the cross-section of the reinforcement patch 6 is also flat. The underside of the thick sheet metal 23 and thin sheet metal 22 is also flat in cross-section. The gap in thickness 24 is then covered by the patchwork sheet metal. The patch is applied before the actual hot forming process. In this way, undercuts with the corresponding need for sliders or segmentation of the tool, for example, is able to be avoided.

FIG. 11E shows the patched tailored welded blank of FIG. 11D in the state after hot forming and press hardening. The previously existing gap between the patchwork sheet metal and the two sheet metals of the tailored welded blank is largely closed as a result of hot forming, so that no corrosion problems occur during subsequent cathodic dip coating KTL of the body and during vehicle use.

The steel grades used are able to be used as examples below and are able to be used for all variants of this present disclosure. In at least one embodiment of the present disclosure, different steel grades are able to be combined with each other in a tailored welded blank. Corresponding strength ranges for hard or soft regions or solid or ductile regions are able to be taken from the table. All alloy components are provided in % by weight, wherein the respective curable steel alloy is then supplemented by residual iron and melting-related impurities.

| 1 | TWB-Ab [symbol] chnitt | C | | Si | | Mn | | P | | S | | Al | | B | | Cr | |
|---|---|---|---|---|---|---|---|---|---|---|---|---|---|---|---|---|---|
| 2 | [symbol] us | min | max | min | max | min | max | min | max | min | max | min | max | min | max | min | max |
| 3 | [symbol] > | 0.19 | 0.25 | 0.1 | 0.4 | 1.1 | 1.4 | | 0.02 | | 0.005 | 0 | 0.06 | 0.001 | 0.005 | | 0.3 |
| | 1350 MPa | | | | | | | | | | | | | | | | |
| 4 | [symbol] | 0.2 | 0.23 | 0.2 | 0.3 | 1.1 | 1.4 | | 0.02 | | 0.006 | 0 | 0.06 | 0.002 | 0.004 | 0.1 | 0.3 |
| | 1500 MPa | | | | | | | | | | | | | | | | |
| 5 | [symbol] > | 0.31 | 0.37 | 0.1 | 0.6 | 1 | 1.5 | | 0.025 | | 0.02 | | 0.1 | 0.001 | 0.004 | 0.06 | 0.35 |
| | 1750 MPa | | | | | | | | | | | | | | | | |
| 6 | [symbol] | 0.33 | 0.35 | 0.15 | 0.35 | 1 | 1.5 | | 0.025 | | 0.025 | 0.01 | 0.08 | 0.001 | 0.004 | 0.06 | 0.5-Mo |
| | 1300 MPa | | | | | | | | | | | | | | | | |
| 7 | [symbol] > | 0.06 | 0.13 | | 0.7 | | 1.9 | | 0.05 | | 0.05 | | 0.1 | | 0.003 | | 0.15 |
| | 450 MPa | | | | | | | | | | | | | | | | |
| 8 | [symbol] | 0.07 | 0.11 | 0.02 | 0.6 | 1.2 | 1.8 | | 0.03 | | 0.01 | 0.01 | 0.07 | 0.0007 | 0.002 | | 0.15 |
| | 800-1000 MPa | | | | | | | | | | | | | | | | |

| 1 | TWB-Ab [symbol] chnitt | Cu | | N | | Nb | | Ni | | Ti | | V | | Mo | |
|---|---|---|---|---|---|---|---|---|---|---|---|---|---|---|---|
| 2 | [symbol] us | min | max | min | max | min | max | min | max | min | max | min | max | min | max |
| 3 | [symbol] > | | 0.1 | | | | 0.05-Ti | 0.1 | 0.02 | 0.01 | 0.1 | | | | 0.3 [symbol] |
| | 1350 MPa | | | | | | | | | | | | | | |
| 4 | [symbol] | | 0.1 | | 0.01 | | 0.05-Ti | 0.1 | 0.02 | 0.02 | 0.05 | | 0.01 | | 0.3 [symbol] |
| | 1500 MPa | | | | | | | | | | | | | | |
| 5 | [symbol] > | | 0.2 | | 0.2 | | 0.1 | | 0.2 | 0.002 | 0.05 | | | | 0.3 [symbol] |
| | 1750 MPa | | | | | | | | | | | | | | |
| 6 | [symbol] | | 0.2 | | 0.2 | 0.01 | 0.05 | | 0.2 | 0.005 | 0.015 | | 0.01 | | 0.5-C [symbol] |
| | 1300 MPa | | | | | | | | | | | | | | |
| 7 | [symbol] > | | 0.2 | | 0.2 | | 0.1 | | | | 1.2 | | 0.1 | | 0 [symbol] |
| | 450 MPa | | | | | | | | | | | | | | |
| 8 | [symbol] | | 0.2 | | 0.2 | 0.04 | 0.1 | | | 0.03 | 0.2 | | 0.1 | | 0 [symbol] |
| | 800-1000 MPa | | | | | | | | | | | | | | |

[symbol]

indicates data missing or illegible when filed

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-12. (canceled)

13. A floor frame for a motor vehicle body, comprising:
at least one longitudinal member which extends in a longitudinal direction of the motor vehicle body; and
at least two cross members which extend in transverse direction of the motor vehicle body,
wherein the at least two cross members and the at least one longitudinal member comprise a profiled cross-section, and the floor frame comprises a one-piece tailored blank formed in one press stroke,
the floor frame comprises connection holes for a battery support, and
the at least two cross members have a lower tensile strength Rm or wall thickness in end regions relative to a central region of each of the at least two cross members.

14. The floor frame according to claim 13, wherein the at least one longitudinal member is offset inwards with respect to a transverse direction of the motor vehicle body or the at least one longitudinal member is on an outside of the motor vehicle body.

15. The floor frame according to claim 13, wherein the at least one longitudinal member and the at least two cross members comprise a double layer in a coupling region thereof.

16. The floor frame according to claim 13, wherein the tailored blank comprises a tailored welded blank, and is formed at least in portions by butt-jointed transition regions welded together.

17. The floor frame according to claim 13, wherein a tensile strength Rm in the end regions is greater than 1350 MPa.

18. The floor frame according to claim 13, wherein the at least one longitudinal member is U-shaped in cross-section, at least in longitudinal portions.

19. The floor frame according to claim 13, wherein the at least two cross members comprise a U-shaped cross-section at least in longitudinal portions.

20. The floor frame according to claim 13, wherein the at least one longitudinal member is L-shaped in cross-section and comprises a flange projecting in an outwardly oriented manner.

21. The floor frame according to claim 13, wherein soft regions have a tensile strength Rm of less than 1000 MPa.

22. The floor frame according to claim 13, wherein the at least one longitudinal member has wall thicknesses that differ from one another along its longitudinal extension.

23. The floor frame according to claim 13, wherein a patch is applied in region of the connection holes.

24. The floor frame according to claim 13, wherein a reinforcing patch is applied at least locally.
